(19) United States
(12) Patent Application Publication
(10) Pub. No.: US 2026/0140984 A1
(43) Pub. Date: May 21, 2026

(54) ONTOLOGY-GROUNDED RETRIEVAL-AUGMENTED GENERATION

(71) Applicant: Microsoft Technology Licensing, LLC, Redmond, WA (US)

(72) Inventors: Peeyush KUMAR, Seattle, WA (US); Kartik SHARMA, Atlanta, GA (US)

(73) Assignee: Microsoft Technology Licensing, LLC, Redmond, WA (US)

(21) Appl. No.: 19/038,374

(22) Filed: Jan. 27, 2025

Related U.S. Application Data
(60) Provisional application No. 63/721,338, filed on Nov. 15, 2024.

(51) Int. Cl. G06F 16/334; G06F 16/36; G06F 16/901; G06F 40/30

(52) U.S. Cl. CPC G06F 16/3347; G06F 16/367; G06F 16/9024; G06F 40/30

(57) ABSTRACT

A computing system including one or more processing devices configured to receive an ontology, receive one or more input documents, and, based at least in part on the ontology, extract ontology-mapped data from the one or more input documents. The one or more processing devices compute a hypergraph of the ontology-mapped data. The one or more processing devices receive an input query and perform similarity matching between the hypergraph and the input query to identify one or more relevant hyperedges. At a generative language model, the one or more processing devices compute a language model output based at least in part on a context that includes the input query, the plurality of relevant hypernodes, and the one or more relevant hyperedges. The one or more processing devices output the language model output.

### CROSS REFERENCE TO RELATED APPLICATIONS

This application claims priority to U.S. Provisional Patent Application Ser. No. 63/721,338, filed Nov. 15, 2024, the entirety of which is hereby incorporated herein by reference for all purposes.

### BACKGROUND

Large language models (LLMs), small language models (SLMs), and large multimodal models (LMMs) have advanced the capabilities of question-answering systems, search engines, and task-oriented chatbots. However, they face significant challenges with fact-based adaptation, particularly in domains that rely on precise, domain-specific data. Consider a precision agriculture system where real-time changes in soil moisture and weather data influence irrigation decisions. A general-purpose LLM can suggest irrigation plans based on broad knowledge but fail to account for specific soil conditions or plant requirements in that region. This lack of adaptability means the LLM's recommendation could be inaccurate, potentially leading to overwatering or under-irrigation, which can harm crops. Such scenarios highlight a core limitation: the inability of LLMs to reliably adapt to domain-specific decision-making, where accuracy and specialized knowledge are paramount.

### SUMMARY

According to one aspect of the present disclosure, a computing system is provided, including one or more processing devices configured to receive an ontology, receive one or more input documents, and, based at least in part on the ontology, extract ontology-mapped data from the one or more input documents. The one or more processing devices are further configured to compute a hypergraph of the ontology-mapped data. The hypergraph includes a plurality of hypernodes and a plurality of hyperedges. The one or more processing devices are further configured to receive an input query. The one or more processing devices are further configured to perform similarity matching between the hypergraph and the input query to identify one or more relevant hyperedges of the hypergraph. At a generative language model, the one or more processing devices are further configured to compute a language model output based at least in part on a context that includes the input query, the plurality of relevant hypernodes, and the one or more relevant hyperedges. The one or more processing devices are further configured to output the language model output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which an ontology and one or more input documents are processed to obtain a hypergraph, according to one example embodiment.

FIG. 2 schematically shows the computing system when the one or more processing devices are further configured to receive an input query and compute a language model output, according to the example of FIG. 1.

FIGS. 3A-3B schematically show an example computation of a language model output from an ontology and one or more input documents, according to the example of FIG. 1.

FIG. 4A shows a flowchart of a method for use with a computing system to perform Ontology-Grounded Retrieval Augmented Generation, according to the example of FIG. 1.

FIGS. 4B-4C show additional steps of the method of FIG. 4A that are performed in some examples.

FIG. 5 shows a schematic view of an example computing environment in which the computing system of FIG. 1 may be instantiated.

### DETAILED DESCRIPTION

To overcome the above difficulties, off-the-shelf LLMs, SLMs, and LMMs can be either fine-tuned for specific domains or paired with external tools or documents. However, fine-tuning is computationally expensive and requires extensive data curation, making it a less practical solution. On the other hand, retrieval-based approaches such as retrieval-augmented generation (RAG) use domain-agnostic embeddings to retrieve query-relevant information from domain-specific documents and use the retrieved information for answering. Although promising, these methods fail to capture the deep conceptual relationships and nuanced facts that are sometimes required for accurate domain-specific retrieval.

Each domain organizes its knowledge and terminology in distinct ways, which cannot be generalized across different fields. For example, in industrial workflows, facts and relationships are carefully curated and structured into domain-specific frameworks, while in knowledge work and investigative research, ontologies serve as templates for organizing and analyzing facts and concepts. Current generative language models struggle to adapt to these diverse structures, limiting their accuracy and effectiveness in specialized domains. Another major issue is that users often struggle to trace generated responses back to the relevant context. Furthermore, many specialized domains follow strict procedural rules, and the current techniques fail to reliably deduce accurate conclusions based on this established domain knowledge. This gap presents a major challenge to the wider applicability of generative language models in specialized workflows.

An Ontology-Grounded Retrieval Augmented Generation (OG-RAG) approach to address the above challenges is provided herein. OG-RAG bridges the above gaps in the capabilities of existing generative language models by integrating domain-specific ontologies for fact-based adaptation. Ontologies, which define key entities and their relationships within a domain, provide structured representation that allows adaptation to complex and evolving information landscapes. OG-RAG leverages these ontologies to enhance language model responses by grounding retrieval within structured domain knowledge, leading to improved response accuracy, supporting flexible fact-based adaptation, and enabling verifiable context attribution. OG-RAG uses hypergraph representations of domain documents, which provide a more sophisticated and multi-faceted way to model relationships than traditional retrieval approaches. Using these hypergraph representations, as discussed in further detail below, OG-RAG distills complex relationships and domain-specific knowledge into a structured context, thereby adapting generative language models to generate context-aware responses without adding significant computational overhead.

OG-RAG applies to a wide set of domains that involve fact-based decision-making. These include industrial workflows in healthcare, legal, and agricultural sectors, as well as knowledge work such as news journalism, web based investigative research, consulting, and more. Evaluations of OG-RAG within the agriculture and news domains, as discussed in further detail below, demonstrate that OG-RAG increases the recall of accurate facts by 55% and improves the overall correctness of generated responses by 40% across four different LLMs. A user study shows that attributing LLM responses to the context retrieved by OG-RAG is 30% faster. Finally, in a fact-based reasoning task, LLM responses are 27% more correct when applying predefined rules over OG-RAG's context compared to other methods. These results highlight OG-RAG's effectiveness in providing more reliable, fact-based answers in specialized workflows.

Prior approaches to domain-specific reasoning in the field of machine learning are discussed below and are compared to OG-RAG. One approach to overcome the limitations of generative language models is fine-tuning on domain-specific data. Fine-tuning allows models to adapt to the nuances of a specific domain by retraining the model on specialized datasets. However, fine-tuning is computationally expensive, requiring significant resources and extensive data curation, which makes it impractical for many real-world applications. OG-RAG addresses this shortcoming by eliminating the need for costly fine-tuning through retrieval-based solutions.

Generative language models are prone to generating hallucinations, i.e., outputs that are factually incorrect or irrelevant to the input. These hallucinations are especially problematic in domains that require precision, such as scientific research or industrial workflows. Existing systems have attempted to mitigate hallucinations through post-generation correction methods and factuality checks, but these often require additional layers of computation and are not foolproof. OG-RAG reduces hallucinations by transforming data-mapped ontologies into hypergraphs and uses optimized retrieval of relevant fact clusters, thereby grounding the language model responses in domain-specific facts.

In addition to traditional retrieval augmented generation (RAG), graph-based approaches have also been proposed. These include GraphRAG, RAPTOR, and other knowledge graph-based frameworks such as Langchain and Neo4J. They have advanced generative language model performance by leveraging structured knowledge graphs to organize and retrieve contextually relevant information. GraphRAG performs semantic clustering by organizing entities and relationships, allowing for more efficient handling of complex queries, while RAPTOR uses a hierarchical structure for multi-level abstraction to improve contextual understanding across large documents. However, these approaches rely on ad-hoc extraction of entities and domain-specific information, often without grounding in domain expertise. This ad-hoc extraction results in overly complex workflows for generating the correct structured representation, while still leaving significant gaps in precision. It also leads to weaker context attribution, making it more difficult to trace conclusions back to relevant facts. In contrast, OG-RAG's hyperedge construction offers a compact fact representation that enhances transparency through better context attribution, while its hypergraph retrieval mechanism selects fact clusters precisely tailored to the query.

To enhance the interpretability and reliability of the generative language model responses, source attribution may be performed on those responses. Generating text with citations is one approach to source attribution. However, prior work has shown limitations of existing zero-shot approaches and specially trained models for attribution. Furthermore, other forms of attribution have also been explored, since citations require users to search over a full page to verify the claims in the generated response. Thus, locally attributable methods and human-in-the-loop strategies have also been proposed. While these approaches provide sentence-level attribution, complementary benefits can be achieved through interpretable RAG contexts. OG-RAG provides easy-to-attribute contexts that require little effort from the users to trace the generation of the response.

Traditional rule-based reasoning systems provide interpretable and easily controllable ways to deduce novel conclusions from a given input. However, they lack the flexibility and generalization capabilities of neural models like LLMs. On the other hand, LLMs, SLMs, and LMMs are prone to arbitrary hallucinations in deductive reasoning, which can be problematic in structured workflows. OG-RAG combines the structured precision of fact-based reasoning with neural flexibility by anchoring unstructured text to domain-specific vocabulary, enabling generative language models to more effectively apply domain-specific rules while maintaining scalability across multiple domains.

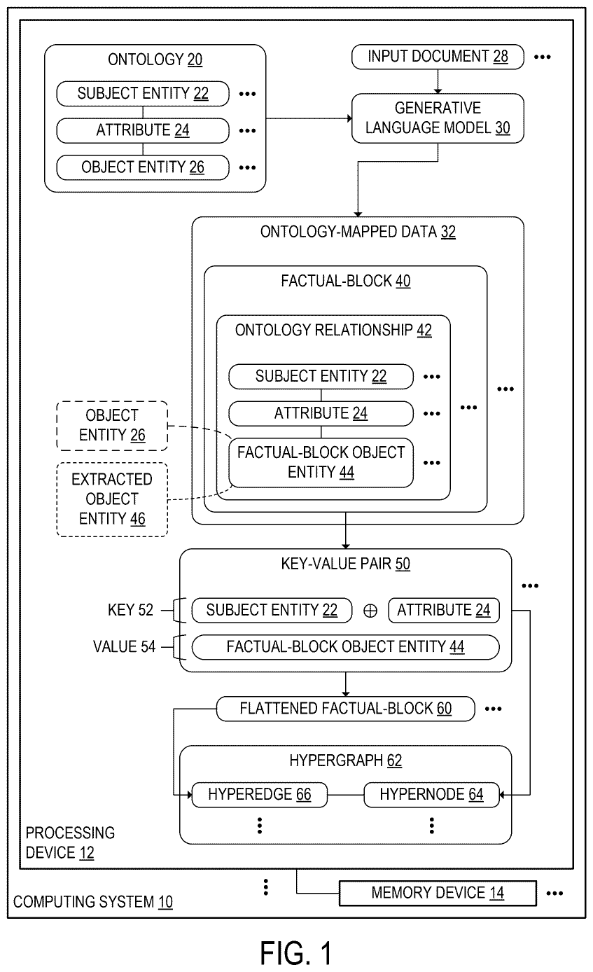

FIG. 1 schematically shows a computing system 10 at which an ontology 20 and one or more input documents 28 are processed to obtain a hypergraph 62. The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices.

In some examples, the one or more processing devices 12 and the one or more memory devices 14 may be distributed among a plurality of different physical computing devices. For example, the physical computing devices included in the computing system 10 may have a server-client configuration. In other examples, the computing system 10 may be implemented at a single physical computing device.

The one or more processing devices 12 are configured to receive an ontology 20. The ontology 20 is a formal representation of key entities and their relationships within a domain. For example, in the agriculture domain, entities like crops, soil, and weather conditions are defined, along with relationships such as “crop is grown in a region” or “soil has moisture level.” By defining these entities and relationships, the ontology 20 provides a consistent and clear framework for organizing domain knowledge. The ontology 20 differs from a taxonomy or a classification, as the ontology 20 allows for richer relationships between entities that need not be hierarchical.

In some examples, a domain-specific ontology 20 may be unavailable or insufficiently comprehensive. In such examples, an ontology learning method may be used to automatically generate a robust baseline ontology. This baseline ontology may be used as a starting point that domain experts can edit and refine to obtain the ontology 20. Additionally, in many fields, rich pre-existing ontologies are already available and can be directly used as the ontology 20.

The ontology 20 includes a plurality of subject entities 22, a plurality of attributes 24, and a plurality of object entities 26. The attributes 24 specify relations between the subject entities 22 and the object entities 26. More formally, an ontology [symbol] ⊆ [symbol] × [symbol] ×( [symbol] ∪{φ}) consists of a set of triples that relate a set of entities [symbol] using a set of attributes [symbol] . The triple (s, a, v)∈ [symbol] denotes that the subject entity s has an attribute a. The value v is either another entity s′∈ [symbol] or an unspecified domain value, denoted by φ. Here, v:=vₒ(s, a) represents the value of the attribute a for the entity s, which is either another entity within the ontology or undefined (unspecified) text or data.

For example, consider a subject entity s=“Crop” that can have an attribute a₁=“is grown in”, which maps it to another object entity vₒ(s, a₁)=s′=“Crop Region”. Additionally, the same entity s can have another attribute a₂=“has name”, which maps it to an arbitrary text. The arbitrary text is denoted as vₒ(s, a₁)=φ, indicating that this value is unspecified and can be any relevant text or name in the domain.

The one or more processing devices 12 are further configured to receive one or more input documents 28. The one or more input documents 28 may be domain-specific documents that have a text format. Extracting factual information from domain-specific input documents 28 may be challenging due to their specialized language and often underspecified structure. Moreover, relevant facts are frequently scattered across separate input documents 28.

To address these challenges, the explicit relationships defined in the ontology 20 may be leveraged to extract factual information from the one or more input documents 28. The one or more processing devices 12 are further configured to process the ontology 20 and the one or more input documents 28 to extract ontology-mapped data 32 from the one or more input documents 28. The ontology-mapped data 32 may be indicated as [symbol] := [symbol] ( [symbol] ), where [symbol] represents the one or more input documents 28.

In the example of FIG. 1, the natural language modeling capabilities of a generative language model 30 are used to compute the ontology-mapped data 32. The generative language model 30 may be an LLM, and SLM, or an LMM, as discussed above. For example, the one or more processing devices 12 may be configured to prompt an LLM to generate the ontology-mapped data 32 in a JSON-LD format. In some examples, other pattern-matching heuristics, rule-based strategies, or embedding-similarity-based approaches may additionally or alternatively be used to map the one or more input documents 28 onto the ontology 20.

Since domain-specific facts are often grounded in the underlying ontology 20, enforcing the relationships included in the ontology 20 can help enrich and disambiguate the information contained in the one or more input documents 28. In particular, the one or more input documents 28 can be used to find values v for attributes 24 by extracting relevant domain-specific text or values from the one or more input documents 28 themselves (i.e., when [symbol] (s, a)=φ). Since domain-specific input documents 28 may include a variety of facts, this value assignment does not have to be unique across all the one or more input documents 28. Instead, different parts of the one or more input documents 28 may provide distinct yet valid text/data values v related to the same subject entity 22.

The ontology-mapped data 32 includes a plurality of factual-blocks 40. The factual-blocks 40 may be indicated as F∈ [symbol] ( [symbol] ). Each of the factual-blocks 40 includes one or more ontology relationships 42 that each include a subject entity 22 of the plurality of subject entities 22 included in the ontology 20, an attribute 24 of the plurality of attributes 24 included in the ontology 20, and a factual-block object entity 44. Each of the factual-block object entities 44 is included in the ontology 20 as an object entity 26 or is an extracted object entity 46 extracted from the one or more input documents 28 using the generative language model 30. Thus, the one or more ontology relationships 42 each map a subject entity 22 to either an unspecified domain text in the set of values [symbol] or another entity within the same factual-block 40. For any relationship (s, a, v)∈F, the one or more processing devices 12 may be configured to derive the value v as follows: if the value [symbol] (s, a)=φ, then v∈ [symbol] is extracted from the one or more input documents 28. Otherwise, v= [symbol] (s, a) is the value provided by the ontology 20. The ontology-mapped data 32 therefore represents self-contained and ontology-grounded information extracted from the one or more domain-specific input documents 28. For example, a factual-block F might represent that a term s=“Seed” is a₁=“of crop” v(s, a₁)=“Soybean”, is a₂=“is grown in” v(s, a₂)=(s′=“Crop Region”, a₃=“has a name”, v(s′, a₃)=“Northwest Region”).

The one or more processing devices 12 are further configured to compute a hypergraph 62 of the ontology-mapped data 32. The hypergraph 62 includes a plurality of hypernodes 64 and a plurality of hyperedges 66. A hypergraph 62 differs from a graph in that the hyperedges 66 of a hypergraph 62 may connect to more than two hypernodes 64, whereas an edge of a graph is limited to having two endpoints. The processes by which the one or more processing devices 12 are configured to compute the hypergraph 62 are discussed below.

The plurality of factual-blocks 40 may form a nested structure within the ontology-mapped data 32. Due to the nested structures of the factual-blocks F∈ [symbol] ( [symbol] ), directly using the factual-blocks 40 for data retrieval may be challenging. The combinatorial nature of multi-layered relationships and dependencies make it difficult to efficiently extract or attribute information, which interferes with the goal of providing compact and accurate context attribution. To address this challenge, the one or more processing devices 12 may be configured to compute the hypergraph 62 at least in part by flattening the nested structure of the plurality of factual-blocks 40. The factual-blocks 40 may accordingly be converted into a set of flattened factual-blocks 60, making the ontology-mapped data 32 easier to handle without significant loss of detail.

An algorithm that performs the factual-block flattening process is provided as follows:

Algorithm 1: Flattening a factual block

```
Require: factual-block F, concatenation operator ⊕.
Ensure: a set of flattened factual-blocks F̅ ← FLATTEN(F) flattens any
nested information present in F.
procedure FLATTEN(F)
  F̅ ← { }
  F̅₀ ← {(s ⊕ a, v): (s, a, v) ∈ F, v ∈ [symbol]    , (s′, a′, s) ∉ F}. [symbol]     no
dependencies, can be directly flattened
  F̅ ← F̅ ∪ {F̅₀}
  for (s′, a′, s) ∈ F\F̅₀ do
    if s′ ∈ [symbol]     then
      F_{s′} ← F̅₀ ∪ {(s ⊕ a ⊕ s′ ⊕ a′, v′): (s′, a′, v′) ∈ F}.
      F̅ ← F̅ ∪ FLATTEN(F_{s′}). [symbol]     flatten nesting of s′
    end if
  end for
  return F̅
end procedure
```

Each flattened factual-block 60 may be defined as a hyperedge e∈ [symbol] , where a hyperedge e connects multiple hypernodes {nᵢ∈ [symbol] }. Each hypernode nᵢ∈F̅ is a primitive set in the flattened factual-block F̅ that can be represented as a key-value pair 50. As shown above in Algorithm 1, the one or more processing devices 12 are configured to flatten the nested structure at least in part by, for each of the factual-blocks 40, computing a respective key-value pair 50 that includes, as a key 52, the subject entity 22 concatenated with the attribute 24. The key-value pair 50 further includes, as a value 54, the factual-block object entity 44. As discussed above, the factual-block object entity may be an object entity 26 included in the ontology 20 or may be an extracted object entity 46.

As shown above in Algorithm 1, flattening the nested structure includes recursively expanding the key-value pairs 50 to compute a plurality of flattened factual-blocks 60. Algorithm 1 maintains the entity relationships stored in the ontology-mapped data 32 without introducing data loss. Using Algorithm 1, the one or more processing devices 12 are configured to capture multi-dimensional relationships between entities, unlike simpler graph-based models that only handle pairwise connections.

The one or more processing devices 12 are further configured to convert the flattened factual-blocks 60 into the hypergraph 62. The hypergraph 62 is defined as [symbol] :=( [symbol] , [symbol] ), where [symbol] are the hypernodes 64 and [symbol] are the hyperedges 66. Each hyperedge e∈ [symbol] is a set of hypernodes with arbitrary length. In addition, [symbol] (X) is defined as the power set of X, and ⊕ X as the set that is formed by concatenating the strings within each element of the set X. Using these definitions, the hyperedges are [symbol] ⊆ [symbol] ( [symbol] ). The hypernodes are [symbol] ⊆[⊕ [symbol] ( [symbol] × [symbol] )]× [symbol] , where x is the Cartesian product. The set of all flattened factual-blocks 60 extracted from the ontology-mapped documents [symbol] form the hypergraph 62. This hypergraph may be denoted [symbol] ( [symbol] ). In the hypergraph 62, the hypernodes 64 are the key-value pairs 50.

The hyperedges 66 of the hypergraph 62 are logical propositions over the key-value pairs 50. These logical propositions are grounded in domain-specific data and each take the form of an assertion that relates a subject entity 22 to an object entity 26 through an attribute 24. The logical propositions can be evidentially verified to be either true or false. For example, a hyperedge 66 may be the assertion hasCropYield (Farm A)=500 tons, where hasCropYield is the functional attribute mapping a farm (subject) to a crop yield (value), and which can be evidentially verified to be either True or False.

A hyperedge 66 may represent a complex logical assertion in some examples. For example, consider two hypernodes, n₁(s₁⊕a₁, v₁)=(Crop has name, Soybean) and n₂(p₂∈⊕ [symbol] ( [symbol] × [symbol] ), v₂)=(Crop has growing zone CropGrowingZone with name, Northwest) forming a hyperedge e=((Crop has name, Soybean), (Crop has growing zone CropGrowingZone with name, Northwest)). This hyperedge can be represented as a simplified logical proposition:

$$hasGrowingZone ( Crop has name Soybean ) = Northwest$$

This logical proposition can be evidentially verified to be True or False.

The hypergraph construction enables a compact and accurate representation of logical relationships that are adapted to the specific domain. This structure may facilitate fact verification by allowing users to inspect the hyperedges 66, which encapsulate the relationships and dependencies between entities.

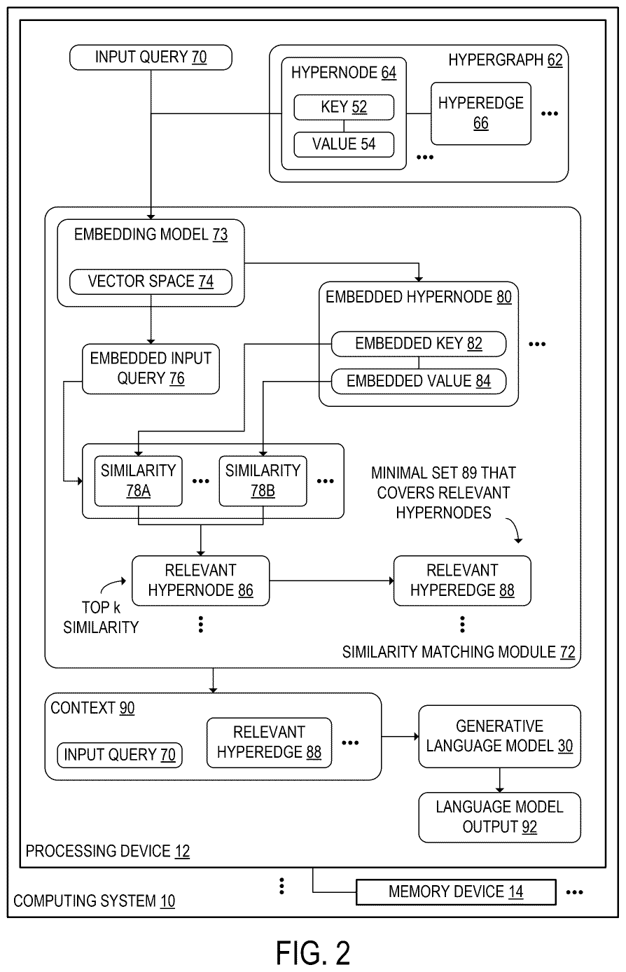

FIG. 2 schematically shows the computing system 10 when the one or more processing devices 12 are further configured to receive an input query 70. The input query 70 may be a text input received from the user via a user interface, such as a graphical user interface (GUI) or an audio interface. The input query 70 may be denoted as Q.

The one or more processing devices 12 are further configured to perform similarity matching between the hypergraph 62 and the input query 70 to identify a plurality of relevant hyperedges 88 of the hypergraph 62. In the example of FIG. 2, the one or more processing devices 12 are configured to execute a similarity matching module 72 to identify the relevant hyperedges 88. At the similarity matching module 72, the one or more processing devices 12 are configured to perform the similarity matching at least in part by mapping the input query 70 and the hypernodes 64 of the hypergraph 62 into a vector space 74. The one or more processing devices 12 may be configured to map the input query 70 and the hypernodes 64 into the vector space 74 by processing the input query 70 and the hypernodes 64 at an embedding model 73. Thus, the one or more processing devices 12 are configured to compute an embedded input query 76 and a plurality of embedded hypernodes 80. Each of the embedded hypernodes 80 is computed from a respective hypernode 64 of the hypergraph 62 and includes an embedded key 82 and an embedded value 84.

Performing the similarity matching further includes identifying the plurality of relevant hypernodes 86 according to respective distances, in the vector space 74, between the input query 70 and the hypernodes 64 of the hypergraph 62. Using the definition discussed above, a hypernode n∈ [symbol] can be represented as a key-value pair 50 computed from the elements in the sets [symbol] , [symbol] , and [symbol] . A hypernode 64 is relevant to the input query 70 if: (1) the input query 70 pertains to an attribute a of the subject entity s, or (2) input query 70 pertains to an object with a specific value v. Thus, a hypernode 64 is a relevant hypernode 86 if either a similarity 78A between the key 52 (representing concatenated entities and attributes) and the input query Q is high, or a similarity 78B between v (the value 54) and the input query Q is high. The one or more processing devices 12 are configured to compute two sets of query-relevant hypernodes: [symbol] (Q) and [symbol] (Q) to represent the two sets respectively. In particular, [symbol] (Q) denotes the top k hypernodes 64 with the highest similarity between their attributed term, i.e., s⊕a and the query Q in the vector space Z, for a predefined constant k. Similarly, [symbol] (Q) represents the top k hypernodes 64 with the highest similarity between their values v and the query Q. Thus, for each input query 70, the system extracts 2·k relevant hypernodes 86. Each of the relevant hypernodes 86 has a top-k similarity between the input query 70 and the key 52 included in the key-value pair 50 that is used as that hypernode 64 in the hypergraph 62, or between the input query 70 and the value 54 included in the key-value pair 50.

The one or more processing devices 12 are further configured to compute the relevant hyperedges 88 as a minimal set 89 of the hyperedges 66 that cover the one or more relevant hypernodes 86. The set of relevant hyperedges 88 is the set of hyperedges [symbol] (Q⊂ [symbol] ) that minimally cover the relevant hypernodes, [symbol] (Q)= [symbol] (Q)∪ [symbol] (Q). The one or more processing devices 12 may be configured to treat relevant hyperedge selection as an optimization problem that is solved in a greedy manner. Since the objective of minimizing the number of relevant hyperedges 88 is linear under a matroid constraint, the one or more processing devices 12 may be configured to compute an exact solution to this optimization problem. For example, the one or more processing devices 12 may be configured to maintain a dictionary that maps each hypernode n∈ [symbol] to the set of hyperedges in which that hypernode is included, i.e., [symbol] (n), where e∈ [symbol] (n)⇒n∈e. In each iteration, the hyperedge 66 that covers the largest number of uncovered hypernodes 64 is added to the set of relevant hyperedges 88. Those hypernodes 64 are then removed from further consideration. This process is repeated until either L relevant hyperedges 88 are obtained or all the relevant hypernodes 86 are covered, where L is a predefined maximum number of relevant hyperedges 88.

At a generative language model 30, the one or more processing devices 12 are further configured to compute a language model output 92 based at least in part on a context 90 that includes the input query 70 and the one or more relevant hyperedges 88. By constructing the minimal set 89 of relevant hyperedges 88 and including that minimal set 89 in the context 90, the one or more processing devices 12 are configured to group semantically related logical propositions together into a context 90 that is both compact and comprehensive. This context 90 may therefore include sufficient detail to support generation of an accurate language model output 92 while also being efficient to compute.

Given the input query Q and the relevant context 90 as found above, a generative language model [symbol] is prompted to use this context 90 to answer the input query as [symbol] ( [symbol] (Q, [symbol] (Q), where [symbol] is a textual prompt. For example, the following prompt may be used:

Given the context below, generate the answer to the given query. Note that the context is provided as a list of valid facts in a dictionary format.
Context: <Line-separated retrieved context [symbol] (Q)>
Query: <User-defined query Q>
Answer:

The one or more processing devices 12 are further configured to output the language model output 92. For example, the one or more processing devices 12 may be configured to output the language model output 92 to a user interface. In some examples, the one or more processing devices 12 may additionally or alternatively be configured to output the language model output 92 to some other computing process. Post-processing may be performed on the language model output 92 in some examples.

The following example algorithm outlines the procedure by which the one or more processing devices 12 are configured to generate the language model output 92. This algorithm includes two phases: (1) a preprocessing phase OG-Preprocess, which is applied once to the ontology 20 and the one or more input documents 28, and (2) a retrieval phase OG-Retrieve, which is used to retrieve the relevant context 90 for each input query 70.

Algorithm 2: Ontology-grounded Retrieval Augmented Generation

```
Require: Query Q, Domain-specific Ontology [symbol]  , Documents [symbol]  , Sentence embedding
function Z, LLM [symbol]  , Maximum length L
Ensure: Retrieved context [symbol]  (Q) is grounded in the ontology and relevant to the query
procedure OG - PREPROCESS( [symbol]  , [symbol]  , [symbol]   ) [symbol]
    ← LLM [symbol]   (Ontology Map ( [symbol]  , [symbol]  ) [symbol]   See definition of ontology-mapped
data [symbol]
  ( [symbol] ) ← Hypergraph with edges [symbol]   FLATTEN(F)
end procedure
procedure OG - RETRIEVE(Q, [symbol]  ( [symbol] ), Z, k, L) [symbol]
  , [symbol]   ← nodes and edges of the hypergraph [symbol]  ( [symbol] )
  ${𝒩}_{S} ( Q ) ← top - k arg {max}_{( s , a , v ) ∈ 𝒩} 〈 Z ( s ⊕ a ) , Z ( Q ) 〉$
  ${𝒩}_{V} ( Q ) ← top - k arg {max}_{( s , a , v ) ∈ 𝒩} 〈 Z ( v ) , Z ( Q ) 〉$ [symbol]
  (Q) ← [symbol]  _{S}(Q) ∪ [symbol]  _{V}(Q) [symbol]
  (Q) ←{ }
  while (| [symbol]  (Q)| > 0) ∨ (| [symbol]  (Q)| < L) do
    ${𝒞}_{ℋ} ( Q ) ← {𝒞}_{ℋ} ( Q ) ⋃ arg {max}_{e ∈ ε} \vert \{ n ∈ 𝒩 ( Q ) iV ( Q ) : n ∈ e \} \vert$
  end while
  return [symbol]   (Q)
end procedure
```

The query complexity of Algorithm 2 is discussed below. The context size of the LLM [symbol] is expressed as N_{c}. The ontology [symbol] , which, for example, can be written in a JSON-LD or textual format, has a length | [symbol] |. The attributes of the ontology, in this example, are mapped to their corresponding ranges in a natural language vocabulary. The OG-Preprocess phase may include one or more LLM calls depending on the number of document chunks in which the LLM ingests the one or more input documents [symbol] . Specifically, the OG-Preprocess phase includes (| [symbol] |+| [symbol] |)/N_{c} LLM calls. The OG-Retrieve procedure does not require any additional LLM calls.

The time complexity of Algorithm 2 is discussed below. The time spent on LLM calls is ignored while calculating the time complexity, since the LLM calls are accounted for under query complexity. Thus, the time complexity of the OG-Preprocess phase is the time complexity of the hypergraph transformation performed by flattening the ontology-mapped data. | [symbol] | factual-blocks are derived from the one or more input documents, and each factual-block has a maximum length of |F|ₘₐₓ=O(| [symbol] |). Two cases are considered: (1) minimal or no nesting: in this case, the time complexity is determined by the step of computing F̅←F̅∪{F̅₀}, leading to a complexity of O(| [symbol] |J|); (2) maximum nesting: in this scenario, computing F̅←F̅∪{F̅₀} may result in an empty set. Thus, each factual-block F can be recursively flattened log| [symbol] | times while searching through the entire set, leading to a time complexity of O(| [symbol] | [symbol] |log| [symbol] |).

The space complexity of Algorithm 2 is discussed below. The only storage required is for the hypergraph structure [symbol] ( [symbol] ), which is directly proportional to the number of hyperedges | [symbol] |=| [symbol] |.

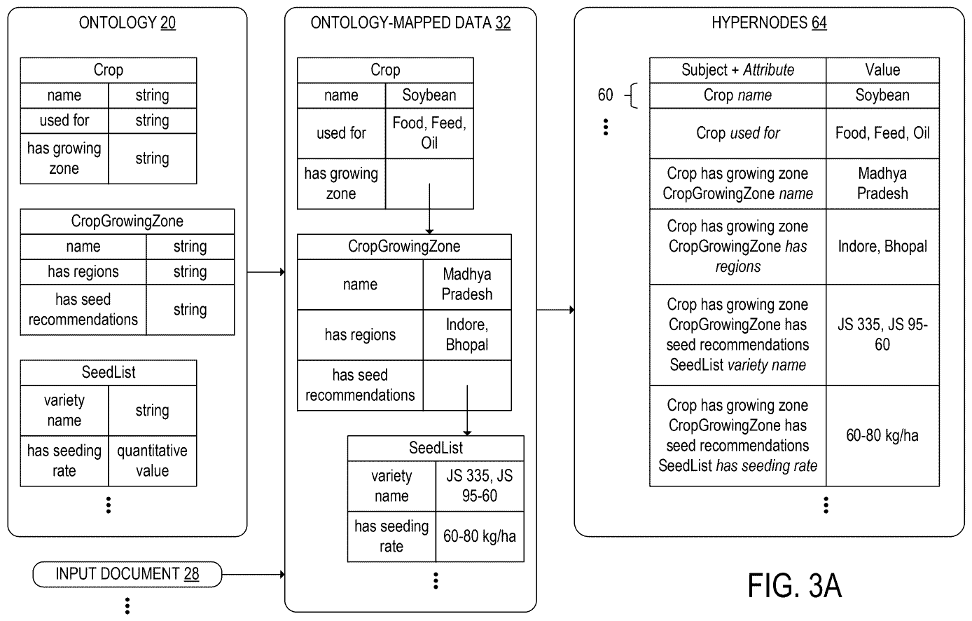

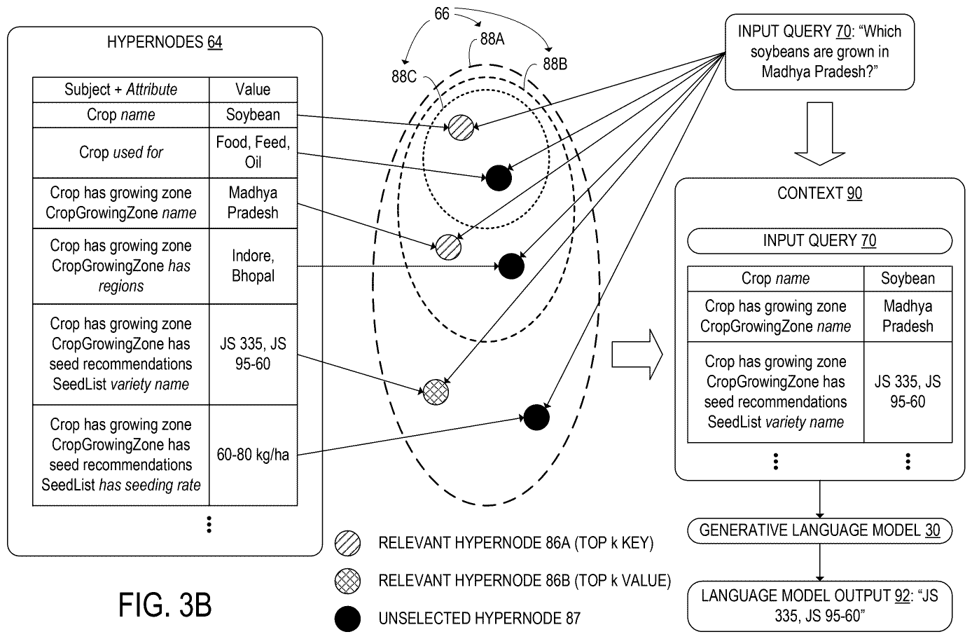

FIGS. 3A-3B schematically show an example computation of a language model output 92 from an ontology 20 and one or more input documents 28 using the techniques discussed above. In the example of FIGS. 3A-3B, the ontology 20 and the one or more input documents 28 are related to agriculture. The one or more processing devices are configured to compute ontology-mapped data 32 from the ontology and the one or more input documents 28, as shown in FIG. 3A, and to flatten the ontology-mapped data 32 into a plurality of flattened factual-blocks 60. The flattened factual-blocks 60 are structured as key-value pairs that form the hypernodes 64 of the hypergraph 62.

FIG. 3B further shows a plurality of hyperedges 66 into which the one or more processing devices 12 are configured to group the hypernodes 64. The one or more processing devices 12 are further configured to identify a plurality of relevant hypernodes 86, including relevant hypernodes 86A associated with the top k highest-similarity keys and relevant hypernodes 86B that have the top k highest-similarity values in a vector space 74, compared to an input query 70. The input query 70 in the example of FIG. 3B is “Which soybeans are grown in Madhya Pradesh?” FIG. 3B further shows a plurality of unselected hypernodes 87 that are not identified as relevant hypernodes 86. The one or more processing devices 12 are further configured to identify relevant hyperedges 88A, 88B, and 88C over the plurality of relevant hypernodes 86.

The one or more processing devices 12 are further configured to compute a context 90 including the input query 70 and the relevant hyperedges 88A, 88B, and 88C, and to input the context 90 into a generative language model 30. The generative language model 30 is configured to compute a language model output 92, “JS 335, JS 95-60.” Thus, the generative language model 30 generates a response to the input query 70 that is grounded in the data stored in the ontology 20 and the one or more input documents 28.

Experiments were performed to evaluate OG-RAG across two distinct domain categories that involve specialized workflows: (a) industrial workflows, with a focus on the agriculture domain, where precise, data-driven decisions are critical for crop management and resource allocation, and (b) knowledge work, where OG-RAG was evaluated on research and analysis tasks in the news domain. General domains like Wikipedia were avoided in order to mitigate potential data contamination in generative language model training. For the agriculture domain, the experiments used two proprietary high-quality datasets including 85 documents prepared by agriculture experts, focusing on the crop cultivation of soybeans and wheat in India. For the news domain, the experiments used the publicly available dataset from Multi-hop RAG was used, filtered for 149 long-form articles (each over 2,000 words) focused on multi-faceted, complex news stories requiring detailed, contextually rich analysis.

A semi-automated approach was used to construct the ontologies for both domains. This semi-automated approach reflects the broader applicability of OG-RAG in specialized workflows. For the agriculture domain, the ontology was generated using an ontology learning module and was then reviewed and verified by multiple experts specializing in crop cultivation. For the news domain, the existing Simple News and Press (SNaP) ontology was modified. Specifically, the structure of SNAP was simplified by excluding certain classes, such as those related to images, videos, and the “stuff” hierarchy. Instead, the news ontology used in the experiments allowed an asset to be linked to multiple events and allowed each event to be associated with multiple organizations and persons.

Four generative language models were considered for zero-shot query answering while adding the retrieved context from different methods. These generative language models included two closed-box models (GPT-40-mini and GPT-40) and two open-source models (Llama-3.1-8B and Llama-3.1-70B). These models were chosen for their advanced natural-language modeling abilities. The experiments considered 4096 completion tokens and used a temperature of 0.

The OG-RAG approach discussed above was compared to three leading retrieval-based methods to demonstrate its effectiveness:

(1) RAG (Retrieval-Augmented Generation) retrieves query-relevant document chunks by embedding them into a vector space and then finding the context based on the maximum chunk-query similarity.

(2) RAPTOR clusters document chunks into hierarchical structures and uses a generative language model to summarize the clusters as additional context. For this experiment, the tree depth was set to three and the collapsed-tree retrieval strategy was used.

(3) GraphRAG retrieves context from a knowledge graph. The knowledge graph is constructed using a generative language model by extracting entities and relationships and clustering them into semantic communities. The default graph construction prompts were used. Retrieval was performed via local search with community level set to two.

The experiments used text-embedding-3-small as the sentence embedding function across all retrieval methods, and GPT-40 was used as the generative language model (i.e., [symbol] ) for pre-processing. For each method, {2, 5} similar contexts were found and the context with the highest performance was selected.

Building on the RAGAS framework, the following metrics were used to assess the quality of the retrieved context and the generated responses:

(1) Context Recall (C-Rec): Proportion of claims in the ground-truth answer that can be attributed to the information present in the retrieved context.

(2) Context Entity Recall (C-ERec): Proportion of entities in the ground-truth answer that are present in the retrieved context.

(3) Answer Similarity (A-Sim): Similarity between the generated response and the ground-truth answer in the embedding space.

(4) Answer Correctness (A-Corr): A combination of answer similarity (defined above) and factual similarity, which is the F1-score between the claims in the ground-truth answer and those in the generated response.

(5) Answer Relevance (A-Rel): Measures how easily the original question can be inferred from the generated response.

A set of question/answer pairs was generated using the RAGAS framework to validate the factual accuracy of OG-RAG. RAGAS prompts a generative language model to generate questions of varying difficulty, each with the corresponding ground-truth answers and contexts. Specifically, up to 100 unique questions from RAGAS were generated. These questions were focused on multi-hop reasoning abilities, which are commonly used in specialized domain tasks.

Context was classified as relevant to a query when that context provided sufficient information for the generative language model to derive the ground-truth response. The context was evaluated using Context Recall and Context Entity Recall. The following table compares the performance of different retrieval methods across three datasets.

| | Soybean | | Wheat | | News | |
|---|---|---|---|---|---|---|
| Method | C-Rec | C-ERec | C-Rec | C-ERec | C-Rec | C-ERec |
| RAG | 0.22 | 0.08 | 0.14 | 0.04 | 0.01 | 0.01 |
| RAPTOR | 0.54 | 0.19 | 0.85 | 0.29 | 0.82 | 0.46 |
| GraphRAG | 0.41 | 0.14 | 0.78 | 0.05 | — | — |
| OG-RAG | 0.84 | 0.41 | 0.95 | 0.34 | 0.82 | 0.52 |

In the above table, the 95% confidence interval is ≤0.05 for all metrics, representing a small margin of error. The symbol “−” denotes that the computation did not complete within one day.

As shown in the above table, OG-RAG outperformed the baselines in almost all cases, boosting the recall of correct claims by 55% and the recall of correct entities by 110%. The only exception was the News dataset, where OG-RAG matched the context recall performance of RAPTOR but still delivered higher context entity recall performance.

Context usefulness was evaluated by comparing how closely the generated responses aligned with the ground-truth answer when added as context across different generative language models. The following table presents the results of response correctness, similarity, and relevance for the 3 datasets.

| | | | | Wheat | | | News | | |
|---|---|---|---|---|---|---|---|---|---|
| | Soybean | A- | A- | A- | A- | A- | A- | A- | A- |
| Method | A-Corr | Sim | Rel | Corr | Sim | Rel | Corr | Sim | Rel |
| Llama-3-8B | | | | | | | | | |
| RAG | 0.26 | 0.59 | 0.22 | 0.26 | 0.65 | 0.23 | 0.15 | 0.52 | 0.08 |
| RAPTOR | 0.34 | 0.66 | 0.59 | 0.54 | 0.76 | 0.67 | 0.53 | 0.74 | 0.68 |
| GraphRAG | 0.26 | 0.63 | 0.52 | 0.43 | 0.35 | 0.27 | — | — | — |
| OG-RAG | 0.40 | 0.65 | 0.60 | 0.54 | 0.73 | 0.72 | 0.52 | 0.76 | 0.69 |
| Llama-3-70B | | | | | | | | | |
| RAG | 0.27 | 0.59 | 0.19 | 0.26 | 0.65 | 0.14 | 0.17 | 0.58 | 0.09 |
| RAPTOR | 0.41 | 0.70 | 0.64 | 0.58 | 0.77 | 0.75 | 0.39 | 0.72 | 0.64 |
| GraphRAG | 0.30 | 0.65 | 0.55 | 0.47 | 0.37 | 0.29 | — | — | — |
| OG-RAG | 0.54 | 0.75 | 0.56 | 0.63 | 0.77 | 0.73 | 0.51 | 0.77 | 0.67 |
| GPT-4o-mini | | | | | | | | | |
| RAG | 0.29 | 0.66 | 0.59 | 0.33 | 0.73 | 0.66 | 0.34 | 0.73 | 0.64 |
| RAPTOR | 0.34 | 0.68 | 0.85 | 0.51 | 0.77 | 0.88 | 0.51 | 0.77 | 0.88 |
| GraphRAG | 0.25 | 0.63 | 0.65 | 0.35 | 0.70 | 0.85 | — | — | — |
| OG-RAG | 0.48 | 0.72 | 0.77 | 0.62 | 0.78 | 0.85 | 0.62 | 0.78 | 0.85 |
| GPT-4o | | | | | | | | | |
| RAG | 0.31 | 0.62 | 0.29 | 0.29 | 0.69 | 0.28 | 0.27 | 0.67 | 0.20 |
| RAPTOR | 0.34 | 0.68 | 0.68 | 0.59 | 0.79 | 0.89 | 0.58 | 0.84 | 0.76 |
| GraphRAG | 0.26 | 0.63 | 0.63 | 0.35 | 0.70 | 0.86 | — | — | — |
| OG-RAG | 0.48 | 0.72 | 0.79 | 0.62 | 0.79 | 0.79 | 0.66 | 0.86 | 0.73 |

In the above table, the 95% confidence interval is ≤0.05 for all metrics. The symbol “−” denotes that the computation did not complete within one day.

As shown in the above table, OG-RAG consistently outperformed the baselines, significantly improving answer correctness by 40% and answer relevance by 16%. The only notable exceptions where OG-RAG slightly underperformed were in answer relevance for the wheat and soybean datasets when used with GPT-40 and Llama-3-70B. This underperformance was likely due to the broad scope of the retrieved context, which sometimes introduced extraneous information.

The pre-processing and per-query retrieval times of OG-RAG were compared with other methods across different datasets in order to test the computational efficiency of OG-RAG. The computational efficiency results are shown in the following table.

| | Soybean | | Wheat | | News | |
|---|---|---|---|---|---|---|
| Method | Tₚᵣₑ ↓ | T_{query} ↓ | Tₚᵣₑ ↓ | T_{query} ↓ | Tₚᵣₑ ↓ | T_{query} ↓ |
| RAG | 11.41 | 2.49 | 10.55 | 2.36 | 449.21 | 3.56 |
| RAPTOR | 71.66 | 4.81 | 61.56 | 4.38 | 1513.57 | 5.45 |
| GraphRAG | 157.04 | 5.95 | 307.37 | 5.65 | — | — |
| OG-RAG | 29.61 | 3.75 | 47.76 | 4.09 | 655.15 | 4.12 |

Tₚᵣₑ ↓ and T_{query} ↓ denote the average pre-processing time and query time in seconds. The variance was within five seconds. The symbol “−” denotes that the computation did not complete within one day.

The above table shows that OG-RAG performed nearly as efficiently as a simple RAG method, with only a minimal increase of at most 2 seconds during querying time despite being at least 100% higher in factual accuracy. OG-RAG was also shown to have significantly lower computational time than more competitive baselines such as RAPTOR and GraphRAG at both the pre-processing and query stages, particularly highlighted by a 50% drop in the pre-processing times. This increased efficiency is valuable in real-time applications such as agricultural monitoring systems, legal research, and automated news fact-checking.

To assess how effectively OG-RAG aids users in verifying facts within LLM-generated responses, a human study was conducted to measure the time taken to verify whether the given context supports the generated response. Ten queries were randomly selected from the agriculture dataset. The responses generated by GPT-40 using both RAG and OG-RAG, each paired with their respective contexts, were presented to the participants. RAPTOR was excluded due to its content similarity with RAG, and GraphRAG due to its prohibitive context length. Participants were asked to evaluate the level of factual support the context provides for the response on a scale of 1-5. The time each participant took to complete this task was also measured. Each participant was shown ten questions. These ten questions included five random queries, each paired with both RAG and OG-RAG responses and contexts in a randomized order. To ensure fairness, each query was presented an equal number of times across all participants.

A total of 16 participants, aged 18-34 and familiar with generative language models, took part in the survey. The following table presents the average time taken and the level of support participants attributed to the contexts.

| Method | Time taken ↓ | Support [1-5] ↑ |
|---|---|---|
| RAG | 61.15 ± 28.48 | 2.67 ± 0.30 |
| OG-RAG | 43.50 ± 18.08 | 3.46 ± 0.19 |

The time taken and the support are presented with 95% confidence intervals in the above table.

The above table shows that OG-RAG significantly reduced the time required by 28.8% and increased the human-attributed support by 29.6% on average. These results demonstrate that OG-RAG not only enables faster fact verification but also provides more robust and clear contexts, making the system more user-friendly and reliable for context fact attribution.

The experiments also assessed the ability of OG-RAG to enhance deductive reasoning in LLMs by evaluating how well OG-RAG can generate new conclusions based on a set of predefined facts. These facts, grounded in domain-specific ontologies, provided the framework for reasoning tasks that required multi-step logic. Specifically, this experiment used six agricultural facts to deduce CO2 emissions, as this information was not directly available in the documents. These facts were partially derived from industry sources on the relationship between fossil fuels, pesticides, and greenhouse gases.

(1) Farm area in the North Eastern Hill zone is 1 hectare or ha.

(2) Farm area in North Plain Hill zone is 2 hectares or ha.

(3) Herbicide production is calculated by multiplying the farm area by the recommended herbicide quantity.

(4) 1 kg of herbicide production results in 18.22-26.63 kg of CO2e emissions.

(5) 1 kg of insecticide production results in 14.79-18.91 kg of CO2e emissions.

(6) 1 kg of fungicide production results in 11.94-29.19 kg of CO2e emissions.

To create the evaluation test set, GPT-40 was prompted, following the RAGAS guidelines, to generate questions that required the application of deductive facts to generate responses. These questions also required a randomly sampled chunk of the ontology-mapped data. Specifically, the following prompt was used:

Given the following data and a set of deductive rules, generate a hard question that requires the application of the rules on the data to generate the answer.
Data: <Domain-specific data>
Rules: <Fixed set of rules>
Question:

Two additional calls to GPT-40 were made to generate the corresponding answer and to assign a rating from 1 to 10, evaluating how well the question tested the application of the rules on the data to derive the answer. Ten questions that received a rating of at least seven were selected.

The following table presents the results of factual deductions across two agriculture datasets, using GPT-40 and GPT-40-mini as the underlying generative language models.

| | Soybean | | | Wheat | | |
|---|---|---|---|---|---|---|
| Method | A-Corr | A-Sim | A-Rel | A-Corr | A-Sim | A-Rel |
| GPT-4o-mini | | | | | | |
| RAG | 0.46 | 0.89 | 0.66 | 0.41 | 0.92 | 0.64 |
| RAPTOR | 0.42 | 0.89 | 0.81 | 0.50 | 0.92 | 0.74 |
| GraphRAG | 0.44 | 0.91 | 0.83 | 0.49 | 0.93 | 0.82 |
| OG-RAG | 0.50 | 0.92 | 0.75 | 0.53 | 0.94 | 0.83 |
| GPT-4o | | | | | | |
| RAG | 0.44 | 0.90 | 0.56 | 0.42 | 0.92 | 0.54 |
| RAPTOR | 0.01 | 0.11 | 0.03 | 0.41 | 0.91 | 0.74 |
| GraphRAG | 0.48 | 0.92 | 0.84 | 0.44 | 0.90 | 0.73 |
| OG-RAG | 0.56 | 0.92 | 0.75 | 0.47 | 0.94 | 0.83 |

In all of the factual deduction cases, except two, the OG-RAG context substantially improved the correctness, similarity, and relevance of the generated answers compared to baseline methods. This demonstrates that OG-RAG is more effective at supporting deductive reasoning from a fixed set of facts. One exception was in the Soybean dataset for answer relevance, which again points to a slightly less pertinent answer due to a broader context retrieved by OG-RAG. Overall, these results confirm that OG-RAG provides a more robust context for deducing new facts than alternative retrieval methods.

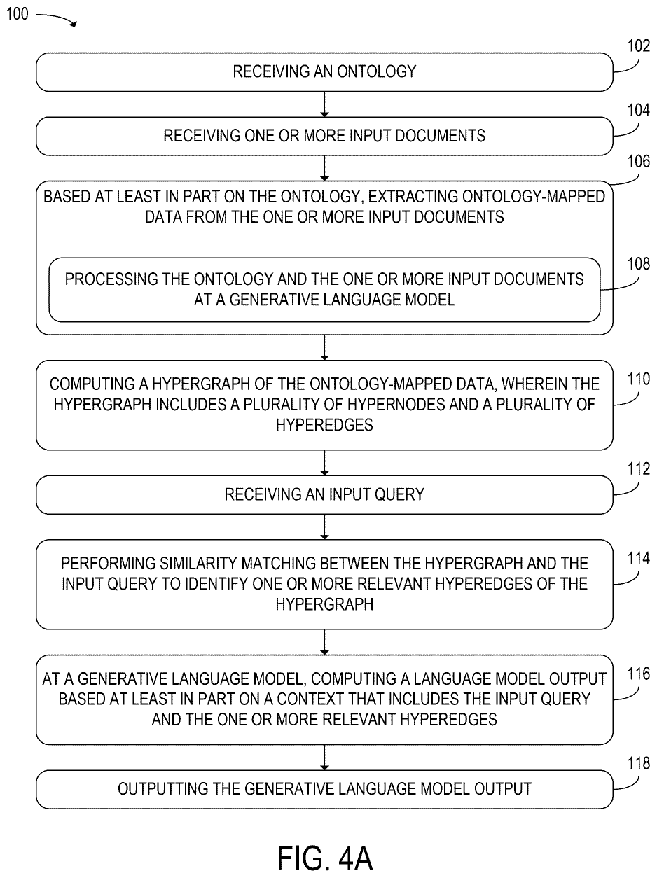

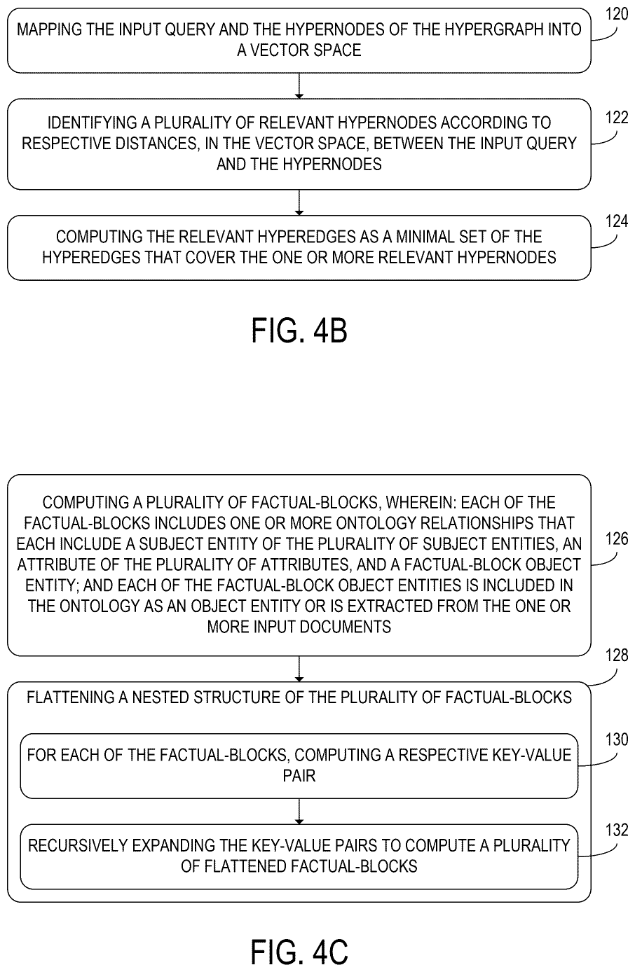

FIG. 4A shows a flowchart of a method 100 for use with a computing system to perform Ontology-Grounded Retrieval Augmented Generation (OG-RAG). At step 102, the method 200 includes receiving an ontology. In some examples, the ontology may include a plurality of subject entities, a plurality of attributes, and a plurality of object entities. The attributes may specify relationships between the subject entities and the object entities in such examples. Thus, the ontology may encode semantic relationships between entities in a specific domain.

At step 104, the method 100 further includes receiving one or more input documents. The one or more input documents may have a text format and may be domain-specific documents related to the domain of the ontology.

At step 106, the method 100 further includes extracting ontology-mapped data from the one or more input documents based at least in part on the ontology. In some examples, at step 108, extracting the ontology-mapped data from the ontology and the one or more input documents may include processing the ontology and the one or more input documents at the generative language model. Extracting the ontology-mapped data at step 108 may include prompting the generative language model with a context that includes the ontology and one or more chunks of the one or more input documents.

At step 110, the method 100 further includes computing a hypergraph of the ontology-mapped data. The hypergraph includes a plurality of hypernodes and a plurality of hyperedges. Restructuring the ontology-mapped data into a hypergraph allows similarity matching between the ontology-mapped data and an input query to be performed more efficiently.

At step 112, the method 100 further includes receiving an input query. The input query may have a text format and may be received as a user input subsequently to the preprocessing of the ontology and the one or more input documents.

At step 114, the method 100 further includes performing similarity matching between the hypergraph and the input query to identify one or more relevant hyperedges of the hypergraph. The input query may accordingly be matched to a portion of the ontology-mapped data that has a high similarity to the input query according to a similarity metric.

At step 116, the method 100 further includes, at a generative language model, computing a language model output based at least in part on a context that includes the input query and the one or more relevant hyperedges. The context of the generative language model is accordingly constructed to include the input query and the portion of the ontology-mapped data that is identified as relevant at step 116.

At step 118, the method 100 further includes outputting the language model output. For example, the language model output may be output to a user interface.

FIG. 4B shows additional steps of the method 100 that may be performed in some examples when similarity matching is performed at step 114. At step 120, the method 100 may further include mapping the input query and the hypernodes of the hypergraph into a vector space. This mapping may be performed at least in part by processing the input query and the hypernodes at an embedding model.

At step 122, the method 100 may further include identifying a plurality of relevant hypernodes according to respective distances, in the vector space, between the input query and the hypernodes. For example, the distances may be L2 distances. Alternatively, the distances may be computed using some other similarity metric such as cosine similarity. In some examples, the hypernodes are key-value pairs. In such examples, the relevant hypernodes may be selected as hypernodes that, for a predetermined constant k, have top-k similarity between the input query and a key included in the key-value pair, or between the input query and a value included in the key-value pair.

At step 124, the method 100 may further include computing the relevant hyperedges as a minimal set of the hyperedges that cover the one or more relevant hypernodes. For example, this minimal set may be identified by iteratively identifying the hyperedge that covers the largest number of uncovered hypernodes.

FIG. 4C shows additional steps of the method 100 that may be performed when computing the ontology-mapped data and the hypergraph at steps 108 and 110. At step 126, computing the ontology-mapped data may include computing a plurality of factual-blocks. Each of the factual-blocks may include one or more ontology relationships that each include a subject entity of the plurality of subject entities, an attribute of the plurality of attributes, and a factual-block object entity. Each of the factual-block object entities may be included in the ontology as an object entity or may be extracted from the one or more input documents.

The plurality of factual-blocks may form a nested structure within the ontology-mapped data. In such examples, at step 128, the method 100 may further include flattening the nested structure of the plurality of factual-blocks. Step 128 may include, at step 130, computing a respective key-value pair for each of the factual-blocks. The key of the key-value pair may be a subject entity concatenated with an attribute, and the value of the key-value pair may be the factual-block object entity.

At step 132, step 128 may further include recursively expanding the key-value pairs to compute a plurality of flattened factual-blocks. In the example of FIG. 4C, the hypernodes of the hypergraph may be the key-value pairs. In addition, the hyperedges may be logical propositions over the key-value pairs. These logical propositions each include a subject entity, an attribute, and an object entity. The logical propositions may be obtained as a result of flattening the factual-blocks. Thus, by flattening the factual-blocks at step 132, the hyperedges of the hypergraph may be obtained.

The above discussion introduces OG-RAG, in which query-relevant context is extracted from one or more input documents using a domain-specific ontology. The mapping of the one or more input documents onto the ontology is encoded as a hypergraph from which query-relevant propositions are extracted for inclusion in the context of a generative language model. OG-RAG has wide applicability in domains which include industrial workflows in healthcare, legal, and agricultural sectors, among others as well as knowledge-driven tasks like news journalism, investigative research, consulting, and more. Extensive experiments on two agriculture datasets and a news dataset demonstrate that OG-RAG significantly improves the factual accuracy of model-generated responses, while also enabling faster attribution of answers to their supporting contexts and more effective deduction of conclusions from domain facts. Fixed ontologies allow generative language models to incorporate controlled vocabulary and perform structured evidence retrieval, which enhances user comprehension of generated responses and facilitates smoother integration of generative language models into industrial workflows and knowledge work. By offering greater flexibility and control over how context is retrieved and utilized, OG-RAG allows for more adaptable and reliable language systems.

The methods and processes described herein are tied to a computing system of one or more computing devices. In particular, such methods and processes can be implemented as a computer-application program or service, an application-programming interface (API), a library, and/or other computer-program product.

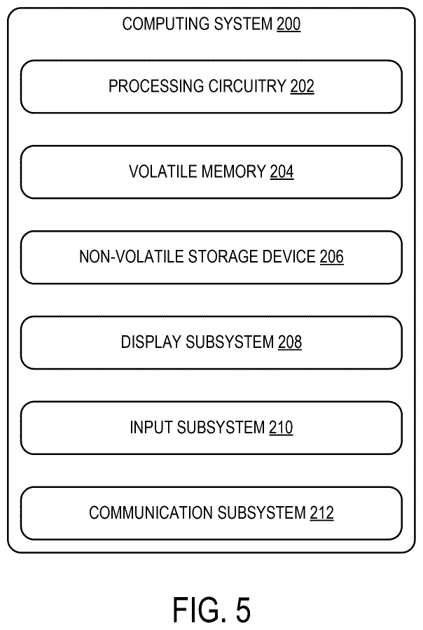

FIG. 5 schematically shows a non-limiting embodiment of a computing system 200 that can enact one or more of the methods and processes described above. Computing system 200 is shown in simplified form. Computing system 200 may instantiate the computing system discussed above with reference to FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 5.

Processing circuitry 202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry 202 optionally may be distributed among two or more separate devices, which may be remotely located and/or configured for coordinated processing. For example, aspects of the computing system 200 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry 202 to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device 206, and thus transform the state of the non-volatile storage device 206, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem 212 may be configured for communication via a wired or wireless local- or wide-area network, broadband cellular network, etc. In some embodiments, the communication subsystem 212 may allow computing system 200 to send and/or receive messages to and/or from other devices via a network such as the Internet.

The following paragraphs discuss several aspects of the present disclosure. According to one aspect of the present disclosure, a computing system is provided, including one or more processing devices configured to receive an ontology and receive one or more input documents. The one or more processing devices are further configured to, based at least in part on the ontology, extract ontology-mapped data from the one or more input documents. The one or more processing devices are further configured to compute a hypergraph of the ontology-mapped data. The hypergraph includes a plurality of hypernodes and a plurality of hyperedges. The one or more processing devices are further configured to receive an input query and perform similarity matching between the hypergraph and the input query to identify one or more relevant hyperedges of the hypergraph. At a generative language model, the one or more processing devices are further configured to compute a language model output based at least in part on a context that includes the input query and the one or more relevant hyperedges. The one or more processing devices are further configured to output the language model output. The above features may have the technical effect of answering a query to a generative language model in a manner that is grounded in domain-specific information, thereby increasing the accuracy, recall, and attributability of generative language model responses in specialized domains.

According to this aspect, wherein the one or more processing devices may be configured to perform the similarity matching at least in part by mapping the input query and the hypernodes of the hypergraph into a vector space. Performing the similarity matching may further include identifying a plurality of relevant hypernodes according to respective distances, in the vector space, between the input query and the hypernodes. The above features may have the technical effect of matching the input query to relevant portions of the hypergraph.

According to this aspect, the one or more processing devices may be configured to compute the relevant hyperedges as a minimal set of the hyperedges that cover the one or more relevant hypernodes. The above features may have the technical effect of selecting contents of the context that encode relationships between the hypernodes identified as relevant.

According to this aspect, the ontology may include a plurality of subject entities, a plurality of attributes, and a plurality of object entities. The above features may have the technical effect of structuring the ontology as a set of triples that each link a subject entity to an object entity via an attribute.

According to this aspect, the ontology-mapped data may include a plurality of factual-blocks. Each of the factual-blocks may include one or more ontology relationships that each include a subject entity of the plurality of subject entities, an attribute of the plurality of attributes, and a factual-block object entity. Each of the factual-block object entities may be included in the ontology as an object entity or is extracted from the one or more input documents. The above features may have the technical effect of encoding the data extracted from the one or more input documents in terms of the structure of the ontology.

According to this aspect, the plurality of factual-blocks may form a nested structure within the ontology-mapped data. The one or more processing devices are configured to compute the hypergraph at least in part by flattening the nested structure of the plurality of factual-blocks. The above features may have the technical effect of encoding complex relationships between entities in the ontology-mapped data. The above features may have the additional technical effect of converting the structure of the ontology-mapped data into a structure that allows vector-matching-based retrieval to be performed on the ontology-mapped data.

According to this aspect, the one or more processing devices may be configured to flatten the nested structure at least in part by, for each of the factual-blocks, computing a respective key-value pair that includes, as a key, the subject entity concatenated with the attribute, and, as a value, the factual-block object entity. Flattening the nested structure further includes recursively expanding the key-value pairs to compute a plurality of flattened factual-blocks. The above features may have the technical effect of flattening the nested structure to compute the hypergraph.

According to this aspect, the hypernodes may be the key-value pairs. The above feature may have the technical effect of computing the hypernodes of the hypergraph from the factual-blocks.

According to this aspect, the hyperedges may be logical propositions over the key-value pairs. The above feature may have the technical effect of computing the hyperedges of the hypergraph from the factual-blocks.

According to this aspect, the one or more processing devices may be further configured to identify a plurality of relevant hypernodes included in the hypergraph. The one or more processing devices may be further configured to compute the plurality of relevant hyperedges based at least in part on the plurality of relevant hypernodes. For a predefined constant k, each of the relevant hypernodes may have a top-k similarity between the input query and a key included in the key-value pair or a value included in the key-value pair. The above features may have the technical effect of selecting the hypernodes that are relevant to the input query.

According to this aspect, the one or more processing devices may be configured to extract the ontology-mapped data from the ontology and the one or more input documents at the generative language model. The above features may have the technical effect of programmatically constructing the ontology-mapped data using the natural language modeling capabilities of the generative language model.

According to another aspect of the present disclosure, a method for use with a computing system is provided. The method includes receiving an ontology and receiving one or more input documents. Based at least in part on the ontology, the method further includes extracting ontology-mapped data from the one or more input documents. The method further includes computing a hypergraph of the ontology-mapped data. The hypergraph includes a plurality of hypernodes and a plurality of hyperedges. The method further includes receiving an input query. The method further includes performing similarity matching between the hypergraph and the input query to identify one or more relevant hyperedges of the hypergraph. At a generative language model, the method further includes computing a language model output based at least in part on a context that includes the input query and the one or more relevant hyperedges. The method further includes outputting the language model output. The above features may have the technical effect of answering a query to a generative language model in a manner that is grounded in domain-specific information, thereby increasing the accuracy, recall, and attributability of generative language model responses in specialized domains.

According to this aspect, performing the similarity matching may include mapping the input query and the hypernodes of the hypergraph into a vector space. Performing the similarity matching may further include identifying a plurality of relevant hypernodes according to respective distances, in the vector space, between the input query and the hypernodes. The above features may have the technical effect of matching the input query to relevant portions of the hypergraph.

According to this aspect, the method may further include computing the relevant hyperedges as a minimal set of the hyperedges that cover the one or more relevant hypernodes. The above features may have the technical effect of selecting contents of the context that encode relationships between the hypernodes identified as relevant.

According to this aspect, the ontology may include a plurality of subject entities, a plurality of attributes, and a plurality of object entities. The above features may have the technical effect of structuring the ontology as a set of triples that each link a subject entity to an object entity via an attribute.

According to this aspect, the ontology-mapped data may include a plurality of factual-blocks. Each of the factual-blocks may include one or more ontology relationships that each include a subject entity of the plurality of subject entities, an attribute of the plurality of attributes, and a factual-block object entity. Each of the factual-block object entities may be included in the ontology as an object entity or may be extracted from the one or more input documents. The above features may have the technical effect of encoding the data extracted from the one or more input documents in terms of the structure of the ontology.

According to this aspect, the plurality of factual-blocks may form a nested structure within the ontology-mapped data. Computing the hypergraph may include flattening the nested structure of the plurality of factual-blocks. Flattening the nested structure may include, for each of the factual-blocks, computing a respective key-value pair. Flattening the nested structure may further include recursively expanding the key-value pairs to compute a plurality of flattened factual-blocks. The above features may have the additional technical effect of converting the structure of the ontology-mapped data into a structure that allows vector-matching-based retrieval to be performed on the ontology-mapped data.

According to this aspect, the hypernodes may be the key-value pairs. The hyperedges may be logical propositions over the key-value pairs. The above features may have the technical effect of computing the hypernodes and hyperedges of the hypergraph from the factual-blocks.

According to this aspect, extracting the ontology-mapped data from the ontology and the one or more input documents may include processing the ontology and the one or more input documents at the generative language model. The above features may have the technical effect of programmatically constructing the ontology-mapped data using the natural language modeling capabilities of the generative language model.

According to another aspect of the present disclosure, a computing system is provided, including one or more processing devices configured to receive an ontology and receive one or more input documents. The one or more processing devices are further configured to process the ontology and the one or more input documents at a generative language model to extract ontology-mapped data from the one or more input documents. The one or more processing devices are further configured to compute a hypergraph of the ontology-mapped data. The hypergraph includes a plurality of hypernodes and a plurality of hyperedges. The one or more processing devices are further configured to receive an input query and map the input query and the hypergraph into a vector space. The one or more processing devices are further configured to identify a plurality of relevant hypernodes according to respective distances, in the vector space, of the input query to the hypernodes of the hypergraph. The one or more processing devices are further configured to identify one or more relevant hyperedges of the hypergraph as a minimal set of the hyperedges that cover the one or more relevant hypernodes. At the generative language model, the one or more processing devices are further configured to compute a language model output based at least in part on a context that includes the input query and the one or more relevant hyperedges. The one or more processing devices are further configured to output the language model output. The above features may have the technical effect of answering a query to a generative language model in a manner that is grounded in domain-specific information, thereby increasing the accuracy, recall, and attributability of generative language model responses in specialized domains.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive an ontology;
receive one or more input documents;
based at least in part on the ontology, extract ontology-mapped data from the one or more input documents;
compute a hypergraph of the ontology-mapped data, wherein the hypergraph includes a plurality of hypernodes and a plurality of hyperedges;
receive an input query;
perform similarity matching between the hypergraph and the input query to identify one or more relevant hyperedges of the hypergraph;
at a generative language model, compute a language model output based at least in part on a context that includes the input query and the one or more relevant hyperedges; and
output the language model output.

2. The computing system of claim 1, wherein the one or more processing devices are configured to perform the similarity matching at least in part by:
mapping the input query and the hypernodes of the hypergraph into a vector space; and
identifying a plurality of relevant hypernodes according to respective distances, in the vector space, between the input query and the hypernodes.

3. The computing system of claim 2, wherein the one or more processing devices are configured to compute the relevant hyperedges as a minimal set of the hyperedges that cover the one or more relevant hypernodes.

4. The computing system of claim 1, wherein the ontology includes a plurality of subject entities, a plurality of attributes, and a plurality of object entities.

5. The computing system of claim 4, wherein:
the ontology-mapped data includes a plurality of factual-blocks;
each of the factual-blocks includes one or more ontology relationships that each include a subject entity of the plurality of subject entities, an attribute of the plurality of attributes, and a factual-block object entity; and
each of the factual-block object entities is included in the ontology as an object entity or is extracted from the one or more input documents.

6. The computing system of claim 5, wherein:
the plurality of factual-blocks form a nested structure within the ontology-mapped data; and
the one or more processing devices are configured to compute the hypergraph at least in part by flattening the nested structure of the plurality of factual-blocks.

7. The computing system of claim 6, wherein the one or more processing devices are configured to flatten the nested structure at least in part by:
for each of the factual-blocks, computing a respective key-value pair that includes:
as a key, the subject entity concatenated with the attribute; and
as a value, the factual-block object entity; and
recursively expanding the key-value pairs to compute a plurality of flattened factual-blocks.

8. The computing system of claim 7, wherein the hypernodes are the key-value pairs.

9. The computing system of claim 8, wherein the hyperedges are logical propositions over the key-value pairs.

10. The computing system of claim 8, wherein the one or more processing devices are further configured to:
identify a plurality of relevant hypernodes included in the hypergraph; and
compute the plurality of relevant hyperedges based at least in part on the plurality of relevant hypernodes,
wherein, for a predefined constant k, each of the relevant hypernodes has a top-k similarity between the input query and:
a key included in the key-value pair; or
a value included in the key-value pair.

11. The computing system of claim 1, wherein the one or more processing devices are configured to extract the ontology-mapped data from the ontology and the one or more input documents at the generative language model.

12. A method for use with a computing system, the method comprising:
receiving an ontology;
receiving one or more input documents;
based at least in part on the ontology, extracting ontology-mapped data from the one or more input documents;
computing a hypergraph of the ontology-mapped data, wherein the hypergraph includes a plurality of hypernodes and a plurality of hyperedges;
receiving an input query;
performing similarity matching between the hypergraph and the input query to identify one or more relevant hyperedges of the hypergraph;
at a generative language model, computing a language model output based at least in part on a context that includes the input query and the one or more relevant hyperedges; and
outputting the language model output.

13. The method of claim 12, wherein performing the similarity matching includes:
mapping the input query and the hypernodes of the hypergraph into a vector space; and
identifying a plurality of relevant hypernodes according to respective distances, in the vector space, between the input query and the hypernodes.

14. The method of claim 13, further comprising computing the relevant hyperedges as a minimal set of the hyperedges that cover the one or more relevant hypernodes.

15. The method of claim 12, wherein the ontology includes a plurality of subject entities, a plurality of attributes, and a plurality of object entities.

16. The method of claim 15, wherein:
the ontology-mapped data includes a plurality of factual-blocks;
each of the factual-blocks includes one or more ontology relationships that each include a subject entity of the plurality of subject entities, an attribute of the plurality of attributes, and a factual-block object entity; and
each of the factual-block object entities is included in the ontology as an object entity or is extracted from the one or more input documents.

17. The method of claim 16, wherein:
the plurality of factual-blocks form a nested structure within the ontology-mapped data; and
computing the hypergraph includes flattening the nested structure of the plurality of factual-blocks, wherein flattening the nested structure includes:
for each of the factual-blocks, computing a respective key-value pair; and
recursively expanding the key-value pairs to compute a plurality of flattened factual-blocks.

18. The method of claim 17, wherein:
the hypernodes are the key-value pairs; and
the hyperedges are logical propositions over the key-value pairs.

19. The method of claim 12, wherein extracting the ontology-mapped data from the ontology and the one or more input documents includes processing the ontology and the one or more input documents at the generative language model.

20. A computing system comprising:
one or more processing devices configured to:
receive an ontology;
receive one or more input documents;
process the ontology and the one or more input documents at a generative language model to extract ontology-mapped data from the one or more input documents;
compute a hypergraph of the ontology-mapped data, wherein the hypergraph includes a plurality of hypernodes and a plurality of hyperedges;
receive an input query;
map the input query and the hypergraph into a vector space; and
identify a plurality of relevant hypernodes according to respective distances, in the vector space, of the input query to the hypernodes of the hypergraph;
identify one or more relevant hyperedges of the hypergraph as a minimal set of the hyperedges that cover the one or more relevant hypernodes;
at the generative language model, compute a language model output based at least in part on a context that includes the input query and the one or more relevant hyperedges; and
output the language model output.
